(19) United States
(12) Patent Application Publication
(10) Pub. No.: US 2025/0086700 A1
(43) Pub. Date: Mar. 13, 2025

(54) COMPUTING SYSTEM TO AUTONOMOUSLY MANAGE CONVERSION OF MANUAL BILL PAY TO AUTOMATIC BILL PAY

(71) Applicant: Wells Fargo Bank, N.A., San Francisco, CA (US)

(72) Inventor: Jonathan Hartsell, Mooresville, NC (US)

(21) Appl. No.: 17/499,623

(22) Filed: Oct. 12, 2021

(51) Int. Cl. G06Q 40/02; G06Q 30/04

(52) U.S. Cl. CPC G06Q 40/02; G06Q 30/04

(57) ABSTRACT

Techniques are described for autonomously managing conversion from a user performing manual payment of recurring bills with one or more billers to automatic payment of the recurring bills with the billers. A computing system identifies, based on transaction data associated with accounts of the user, recurring transactions with a biller that are manually performed by the user, wherein the recurring transactions did not occur through a bank-based payment service and did not occur through automatic payment with a biller-based payment service. The computing system determines, based on the recurring transactions, a recommendation to automatically perform subsequent recurring transactions with the biller; sends, to a user device, a notification of the recurring transactions and the recommendation to automatically perform the subsequent recurring transactions with the biller; and upon receipt of an approval of the recommendation from the user device, autonomously establishes automatic payment of the subsequent recurring transactions with the biller.

### TECHNICAL FIELD

The disclosure relates to computing systems, and more specifically, autonomous controls of computer-based payment systems.

### BACKGROUND

Many customers use their financial institution's online banking system to perform transactions from their accounts, e.g., online bill pay, money transfers, stock trades, fund allocation changes, and other wealth management activities. For example, a customer may securely access a website of the online banking system via a computing device executing a browser, an application, or other software capable of supporting the website. The computing device may be any of a wide range of devices, including a laptop or desktop computer, tablet computer, so-called “smart” phone, “smart” pad, “smart” watch, an Internet of Things (IoT) device, or other personal digital appliance equipped for wired or wireless communication.

In some examples, to perform online bill pay with one or more billers, a customer may enroll in a bank-based payment service via the online banking system. The bank-based payment service may allow the customer to manually schedule automatic payments for a set amount to the biller, or set up receipt of electronic bills with variable amounts from the biller with automatic payments to the biller. In other examples, a customer may manually pay each bill using a payment card, a check, or an automated clearing house (ACH) payment directly to the biller via mail, telephone, or an online biller-based payment service.

### SUMMARY

In general, this disclosure describes a computing system associated with a financial institution that is configured to autonomously manage conversion from a user performing manual payment of recurring bills with one or more billers to automatic payment of the recurring bills with the billers. More specifically, this disclosure describes techniques in which the computing system analyzes transaction data associated with one or more accounts of the user to identify one or more recurring transactions with a particular biller that are manually performed by the user from at least one account of the one or more accounts, and where the recurring transactions did not occur through a bank-based payment service and did not occur through automatic payment with a biller-based payment service. The computing system then determines a recommendation to automatically perform subsequent recurring transactions with the biller via a type of automatic payment identified as a best fit for the user, the biller, and/or the financial institution. The computing system sends a notification of the identified recurring transactions and the recommendation to the user, and upon receipt of an approval of the recommendation, autonomously establishes automatic payment of the subsequent recurring transactions with the biller.

The emergence of online bill pay has created a multitude of options for customers and for billers in terms of how to pay and receive payment, respectively. The multitude of options may cause a customer to continue to use whatever payment type they are comfortable with, but that may not be the most beneficial payment type for the customer. In addition, even if a customer is aware that using an automatic payment type would be beneficial, the customer may be uncomfortable setting up the automatic payments or unsure of which type of automatic payment service to use. The techniques of this disclosure provide computer-based recognition of manual, recurring transactions with a biller, and determination of a type of automatic payment for subsequent recurring transactions with the biller that has the highest probability of successful usage based on the transaction data of the recurring transactions, user profile data, and biller profile data. In addition, techniques of this disclosure provide autonomous establishment of the recommended automatic payment with the biller-based payment service or the bank-based payment service. In this way, the user does not need to manually initiate payment of each bill and, furthermore, does not even need to manually set up automatic payment for subsequent bills.

In one example, this disclosure is directed to a computer-implemented method comprising: establishing, by a computing system, a communication session with a user computing device during which the user computing device has secure access via an online banking system to one or more accounts associated with a user of the user computing device; identifying, by the computing system and based on transaction data associated with the one or more accounts of the user, one or more recurring transactions with a biller that are manually performed by the user from at least one account of the one or more accounts, wherein the recurring transactions did not occur through a bank-based payment service of the online banking system and did not occur through automatic payment with a biller-based payment service; determining, by the computing system based on the recurring transactions, a recommendation to automatically perform subsequent recurring transactions with the biller; sending, by the computing system and to the user computing device, a notification of the recurring transactions and the recommendation to automatically perform the subsequent recurring transactions with the biller; and upon receipt of input data representative of an approval of the recommendation from the user computing device during the communication session, establishing, by the computing system, automatic payment of the subsequent recurring transactions with the biller.

In another example, this disclosure is directed to a computing system comprising one or more storage devices and processing circuitry having access to the storage devices. The processing circuitry configured to: establish a communication session with a user computing device during which the user computing device has secure access via an online banking system to one or more accounts associated with a user of the user computing device; identify, based on transaction data associated with the one or more accounts of the user, one or more recurring transactions with a biller that are manually performed by the user from at least one account of the one or more accounts, wherein the recurring transactions did not occur through a bank-based payment service of the online banking system and did not occur through automatic payment with a biller-based payment service; determine, based on the recurring transactions, a recommendation to automatically perform subsequent recurring transactions with the biller; send, to the user computing device, a notification of the recurring transactions and the recommendation to automatically perform the subsequent recurring transactions with the biller; and upon receipt of input data representative of an approval of the recommendation from the user computing device during the communication session, establish automatic payment of the subsequent recurring transactions with the biller.

In a further example, this disclosure is directed to a non-transitory computer readable medium including instructions that when executed cause one or more processors to: establish a communication session with a user computing device during which the user computing device has secure access via an online banking system to one or more accounts associated with a user of the user computing device; identify, based on transaction data associated with the one or more accounts of the user, one or more recurring transactions with a biller that are manually performed by the user from at least one account of the one or more accounts, wherein the recurring transactions did not occur through a bank-based payment service of the online banking system and did not occur through automatic payment with a biller-based payment service; determine, based on the recurring transactions, a recommendation to automatically perform subsequent recurring transactions with the biller; send, to the user computing device, a notification of the recurring transactions and the recommendation to automatically perform the subsequent recurring transactions with the biller; and upon receipt of input data representative of an approval of the recommendation from the user computing device during the communication session, establish automatic payment of the subsequent recurring transactions with the biller.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example network system that includes an automatic payment conversion manager configured to autonomously manage conversion from manual bill pay to automatic bill pay, in accordance with the techniques of this disclosure.

FIG. 2 is a block diagram illustrating an example computing system including an automatic payment conversion manager, in accordance with the techniques of this disclosure.

FIG. 3 is a conceptual diagram illustrating an example recommendation user interface of an online banking system used to present a payment history including recurring transactions and a recommendation to automatically perform the recurring transactions, in accordance with the techniques of this disclosure.

FIG. 4 is a conceptual diagram illustrating an example automatic payment confirmation user interface of the online banking system used to present payment information and a receive modifications or confirmation of the payment information for automatic payments, in accordance with the techniques of this disclosure.

FIGS. 5A and 5B are conceptual diagrams illustrating examples of a bill pay control user interface of the online banking system used to present bill pay settings, in accordance with the techniques of this disclosure.

FIG. 6 is a flowchart illustrating an example operation of an automatic payment conversion manager running on a computing system, in accordance with the techniques of this disclosure.

### DETAILED DESCRIPTION

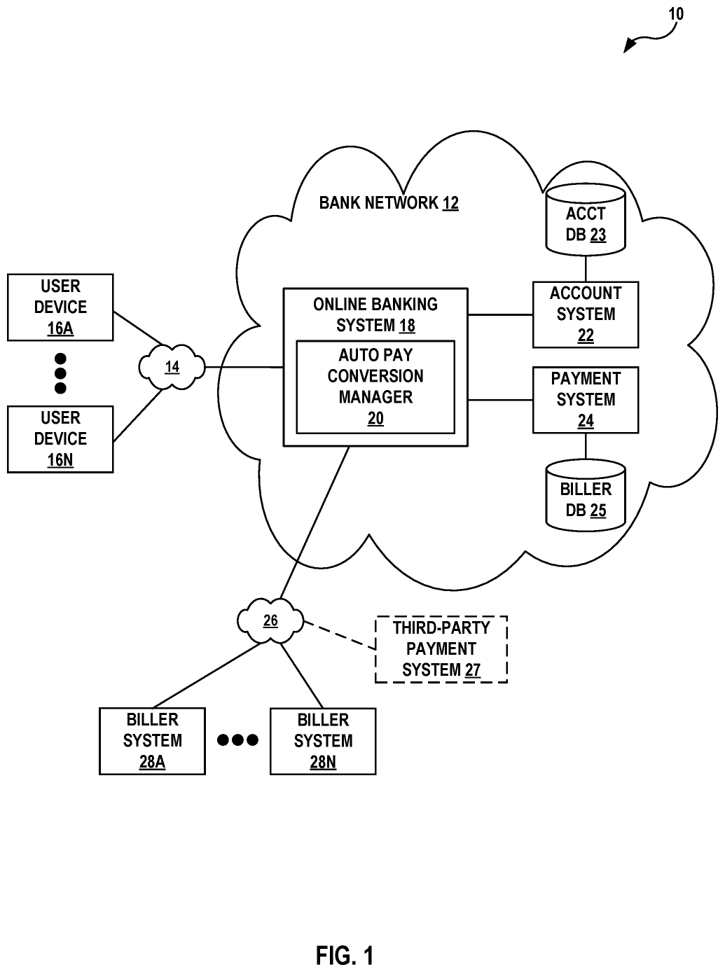

FIG. 1 is a block diagram illustrating an example network system 10 that includes an automatic payment conversion manager 20 configured to autonomously manage conversion from manual bill pay to automatic bill pay, in accordance with the techniques of this disclosure. As illustrated in FIG. 1, network system 10 includes one or more user computing devices 16A-16N (collectively, “user devices 16”) in communication with an online banking system 18 hosted on bank network 12 via a network 14. In addition, network system 10 includes one or more biller computing systems (collectively, “biller systems 28”) in communication with online banking system 18 hosted on bank network 12 via a network 26. Biller systems 28 may comprise computing systems of one or more utilities, merchants, vendors, or the like that provides services to one or more users of user devices 16 and bills or invoices for the provided services on a period basis, e.g., monthly.

Bank network 12 may comprise at least a portion of a large-scale enterprise network used or administered by a large organization, such as a financial institution or bank. Bank network 12 may comprise a centralized or distributed network of disparate computing systems made up of interconnected desktop computers, laptops, workstations, wireless devices, network-ready appliances, file servers, print servers, or other computing devices. For example, bank network 12 may comprise one or more data centers including a plurality of servers configured to provide account services interconnected with a plurality of databases and other storage facilities. In the example of FIG. 1, bank network 12 includes an account system 22 that has access to an account database 23 that stores user account information and, in some cases, user profiles. Bank network 12 also includes a payment system 24 that has access to a biller database 25 that stores biller profiles and, in some cases, biller account information.

Account system 22 may update and/or maintain account database 23. Account database 23 may comprise a database of one or more account types held by one or more users at the financial institution. For example, for a given user of the financial institution, an account type may be “checking,” “savings,” “credit,” or any other suitable account type. In some examples, account database 23 may additionally include specific account numbers associated with the one or more account types held by the one or more users. The information stored in account database 23 may be searchable and/or categorized such that one or more tools within account system 22 may provide an input requesting information from account database 23, and in response to the input, receive information stored within account database 23. Account database 23 may include one or more user profiles for the one or more users of the financial institution. The user profile data for a particular user may include contact information for the particular user and preferred payment information, e.g., debit card, credit card, or ACH.

Payment system 24 may update and/or maintain biller database 25. Biller database 25 may comprise a database of billers associated with payment system 24 that have existing relationships with the financial institutions and may be enrolled in a bank-based payment service managed by online banking system 18. The information stored in biller database 25 may be searchable and/or categorized such that one or more tools within payment system 24 may provide an input requesting information from biller database 25, and in response to the input, receive information stored within biller database 25. Biller database 25 may include one or more biller profiles for the one or more billers. The biller profile data for a particular biller may include a category or type of the particular biller, e.g., utility, services, entertainment, etc. The biller profile data may additionally include contact information for the biller, the associated one or biller systems 28, and/or the biller's bank. The biller profile data may further include preferred payment information, e.g., ACH or credit card.

User devices 16 may each comprise any of a wide range of user computing devices, including laptop or desktop computers, tablet computers, so-called “smart” phones, “smart” pads, “smart” watches, Internet of Things (IoT) devices, or other personal digital appliances equipped for wired or wireless communication. Each of user devices 16 may include at least one user interface device (not shown) that enables a user of the respective computing device to interact with the computing device. In some examples, the user interface device may be configured to receive tactile, audio, or visual input. In addition to receiving input from the user, the user interface device may be configured to output content such as a graphical user interface (GUI) for display, e.g., at a display device associated with the respective computing device.

Online banking system 18 of bank network 12 may include one or more servers or other computing devices configured to establish a communication session with one of user devices 16, e.g., user device 16A, to provide secure access to one or more accounts at the financial institution that are associated with a user of user device 16A. For example, online banking system 18 may include a plurality of access servers configured to host website portals to online banking system 18 through which external computing devices, e.g., user devices 16, may securely access one or more accounts maintained by bank network 12.

User devices 16 may interact with online banking system 18 through network 14, and may access functionality of bank network 12 provided by online banking system 18. For example, a user may securely access a website portal of online banking system 18 using user device 16A executing a browser, an application, or other software capable of supporting the website. The access servers of online banking system 18 may authenticate the user based on credentials of the user received from user device 16A, and enable user device 16A to perform transactions with one or more user accounts of the user, e.g., online bill pay, money transfers, stock trades, fund allocation changes, and other wealth management activities, via the website portal of online banking system 18. As shown in FIG. 1, online banking system 18 has access to account system 22 and payment system 24 along with their associated databases in order to perform transactions requested by user device 16A.

In the example of online bill pay, the user of user device 16A may enroll in a bank-based payment service via online banking system 18 to pay bills issued by a biller associated with one of biller systems 28, e.g., biller system 28A. The bank-based payment service may allow the user to manually schedule automatic payments for a set amount to the biller, or set up receipt of electronic bills with variable amounts from the biller with automatic payments to the biller. To facilitate bill payment, online banking system 18 may interact with account system 22 to associate one or more accounts of the user of user device 16A with the bill payment, and may interact with payment system 24 to instruct performance of the bill payment with biller system 28A. In one example, to perform the bill payment, payment system 24 may send a bank check to biller system 28A via the mail and deduct the funds from the user's account based on payment information provided by the user upon enrollment in the bank-based payment service. In another example, to perform the bill payment, payment system 24 may perform an inter-bank transfer with the biller's bank and then deduct the funds from the user's account based on payment information provided by the user upon enrollment in the bank-based payment service.

In other examples, one or more of user devices 16 may interact directly with one or more of biller systems 28 to manage services provided by the billers and/or pay bills. For example, a user of user device 16B may not use the bank-based payment service of online banking system 18 for bill payment to a biller associated with biller system 28B. Instead, the user of user device 16B may manually pay each bill using a payment card (e.g., credit card or debit card), a check, or an automated clearing house (ACH) payment directly to the biller via mail, telephone, or an online biller-based payment service hosted on biller system 28B.

The emergence of online bill pay has created a multitude of options for customers and for billers in terms of how to pay and receive payment, respectively. The multitude of options may cause a customer to continue to use whatever payment type they are comfortable with, but that may not be the most convenient or beneficial payment type for the customer. In addition, even if a customer is aware that using an automatic payment type would be beneficial, the customer may be uncomfortable setting up the automatic payments or unsure of which type of automatic payment service to use. The techniques of this disclosure provide computer-based recognition of manual recurring transactions with a biller, and determination of a type of automatic payment for subsequent recurring transactions with the biller that has the highest probability of successful usage based on the transaction data of the recurring transactions, user profile data, and biller profile data. In addition, techniques of this disclosure provide autonomous establishment of the recommended automatic payment with the biller-based payment service or the bank-based payment service.

According to the techniques described in this disclosure, online banking system 18 includes automatic payment (“auto pay”) conversion manager 20 that is configured to autonomously manage conversion from a user of one of user devices 16, e.g., user device 16A, performing manual payment of recurring bills with one or more billers of one or more biller systems 28 to automatic payment of the recurring bills with the billers. More specifically, auto pay conversion manager 20 analyzes transaction data associated with one or more accounts of the user, e.g., stored in account database 23, to identify one or more recurring transactions with a particular biller, e.g., a biller associated with biller system 28A, that are manually performed by the user from at least one account of the one or more accounts. Auto pay conversion manager 20 also determines that the recurring transactions did not occur through the bank-based payment service and did not occur through automatic payment with the biller-based payment service.

As one example, auto pay conversion manger 20 may identify recurring transactions based on two or more transactions from the user's accounts with the same biller that occurred according to approximately a same periodic interval, e.g., monthly, and for approximately the same amount. As another example, auto pay conversion manger 20 may identify recurring transactions based on even a single transaction from the user's accounts with a biller that is identified in biller database 25 as a service provider that has a periodic billing cycle. In either example, auto pay conversion manager 20 may determine that the recurring transactions did not occur through any type of automatic payment service based on automatic payment records of the user stored in account database 23 or another database by online banking system 18 that indicate the user's enrollment in automatic payment services. In some cases, auto pay conversion manger 20 may determine that the recurring transactions did not occur through any type of automatic payment service based on variations in the previous recurring transactions, such as payment on different days in successive pay periods or payment from different accounts of the user in successive pay periods.

Upon identifying the recurring transactions with the biller, auto pay conversion manager 20 determines a recommendation to automatically perform subsequent recurring transactions with the biller of biller system 28A via a type of automatic payment identified as a best fit for the user, the biller, and/or the financial institution. In some examples, auto pay conversion manager 20 may include a machine learning (ML)-based model trained using business rules that are weighted for preferred payment types. Auto pay conversion manager 20 may input the recurring transactions, user profile data, and biller profile data as input to the ML-based model, and identify the type of automatic payment that has a highest probability of successful usage by the user, the biller and/or the financial institution as output from the ML-based model.

Auto pay conversion manager 20 then sends a notification of the identified recurring transactions and the recommendation to user device 16A. For example, auto pay conversion manager 20 may output the notification via a GUI of online banking system 18 during a communication session with user device 16A, or as an electronic message that includes a hyperlink to the GUI of online banking system 18. Upon receipt of an approval of the recommendation from the user via user device 16A via the GUI of online banking system 18, auto pay conversion manager 20 autonomously establishes automatic payment of the subsequent recurring transactions with the biller via biller system 28A. For example, auto pay conversion manager 20 may generate a GUI for display on user device 16A to receive confirmation of payment information for the subsequent recurring transactions with the biller.

In one example, auto pay conversion manger 20 may establish the automatic payment of the subsequent recurring transactions with the biller of biller system 28A by facilitating enrollment of the user of user device 16A in a bank-based payment service. In another example, auto pay conversion manager 20 may establish the automatic payment of the subsequent recurring transactions with the biller of biller system 28A by autonomously enrolling the user of user device 16A in the biller-based payment service, and autonomously scheduling the automatic payment of the subsequent recurring transactions with the biller via the biller-based payment service of biller system 28A. As illustrated in FIG. 1, online banking system 18 may interact with biller systems 28 through network 26. In some examples, a third-party payment system 27 may operate as an intermediary between one or more components of bank network 12 and one or more of biller systems 28. In those examples, auto pay conversion manager 20 may autonomously enroll and schedule automatic payment with third-party payment system 27, which in turn facilitates payment to biller system 28A.

In the example of FIG. 1, network system 10 might include all of the components shown in FIG. 1. Further, in some examples, a network system may not include third-party payment systems or other payment intermediaries, e.g., third-party payment system 27, between bank network 12 and biller systems 28. The optional nature of third-party payment system 27 is indicated through the use of a dashed outline.

Each of the computing systems illustrated in FIG. 1 (e.g., online banking system 18, account system 22, payment system 24, and biller systems 28) may represent any suitable computing system, such as one or more server computers, cloud computing systems, mainframes, appliances, desktop computers, laptop computers, mobile devices, and/or any other computing device that may be capable of performing operations in accordance with one or more aspects of the present disclosure. One or more of such devices may perform operations described herein as a result of instructions, stored on a computer-readable storage medium, executing on one or more processors. The instructions may be in the form of software stored on one or more local or remote computer readable storage devices. In other examples, one or more of such computing devices may perform operations using hardware, firmware, or a mixture of hardware, software, and firmware residing in and/or executing at each of such computing devices.

Each of the networks illustrated in FIG. 1 (e.g., bank network 12, network 14, and network 22) may include or represent any public or private communications network or other network. One or more client devices, server devices, or other devices may transmit and receive data, commands, control signals, and/or other information across such networks using any suitable communication techniques. In some examples, each of bank network 12, network 14, or network 26 may be a separate network, as illustrated in FIG. 1, or one or more of such networks may be a subnetwork of another network. In other examples, two or more of such networks may be combined into a single network; further, one or more of such networks may be, or may be part of, the Internet. Accordingly, one or more of the devices or systems illustrated in FIG. 1 may be in a remote location relative to one or more other illustrated devices or systems. Each of bank network 12, network 14, or network 26 illustrated in FIG. 1 may include one or more network hubs, network switches, network routers, network links, satellite dishes, or any other network equipment. Such devices or components may be operatively inter-coupled, thereby providing for the exchange of information between computers, devices, or other components (e.g., between one or more user devices or systems and one or more server devices or systems).

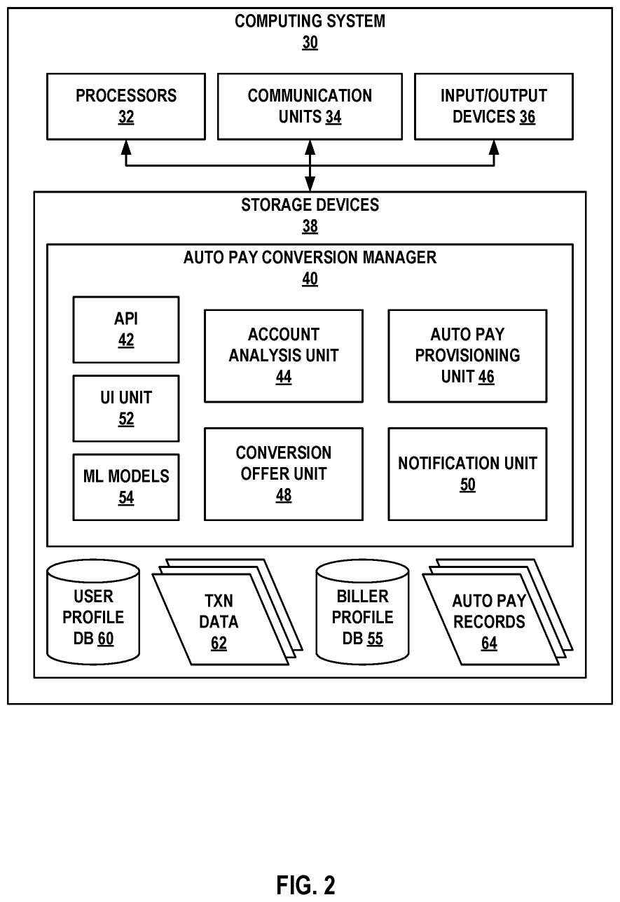

FIG. 2 is a block diagram illustrating an example computing system 30 including an automatic payment conversion manager 40, in accordance with the techniques of this disclosure. Computing system 30 may generally correspond to a device that includes and/or implements aspects of the functionality of online banking system 18 illustrated in FIG. 1. Accordingly, computing system 30 executing automatic payment (“auto pay”) conversion manager 40 may perform some or all of the same functions described in connection with FIG. 1 as being performed by auto pay conversion manger 20 within online banking system 18.

Computing system 30 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 30 represents a cloud computing system, server farm, and/or server cluster (or portion thereof) that provides services to user devices and other devices or systems. In other examples, computing system 30 may represent or be implemented through one or more virtualized compute instances (e.g., virtual machines, containers) of a data center, cloud computing system, server farm, and/or server cluster.

Although computing system 30 of FIG. 2 is illustrated as a stand-alone device, in other examples computing system 30 may be implemented in any of a wide variety of ways, and may be implemented using multiple devices and/or systems. In some examples, computing system 30 may be, or may be part of, any component, device, or system that includes a processor or other suitable computing environment for processing information or executing software instructions and that operates in accordance with one or more aspects of the present disclosure. In some examples, computing system 30 may be fully implemented as hardware in one or more devices or logic elements.

In the example of FIG. 2, computing system 30 includes one or more processors 32, one or more communication units 34, one or more input/output devices 36, and one or more storage devices 38. Storage devices 38 may include auto pay conversion manager 40 including an application programming interface (API) 42, an account analysis unit 44, an auto pay provisioning unit 46, a conversion offer unit 48, a notification unit 50, a user interface (UI) unit 52, and one or more machine learning (ML)-based models 54. Storage devices 38 may further include a user profile database 60, transaction records 62, a biller profile database 55, and auto pay records 64. One or more of the devices, modules, storage areas, or other components of computing system 30 may be interconnected to enable inter-component communications (physically, communicatively, and/or operatively). In some examples, such connectivity may be provided by through communication channels, a system bus, a network connection, an inter-process communication data structure, or any other method for communicating data. A power source (not shown) provides power to one or more components of computing system 30. In some examples, the power source may receive power from the primary alternative current (AC) power supply in a commercial building or data center, where some or all of an enterprise network may reside. In other examples, the power source may be or may include a battery.

One or more processors 32 of computing system 30 may implement functionality and/or execute instructions associated with computing system 30 associated with one or more modules illustrated herein and/or described below. One or more processors 32 may be, may be part of, and/or may include processing circuitry that performs operations in accordance with one or more aspects of the present disclosure. Examples of processors 32 include microprocessors, application processors, display controllers, auxiliary processors, one or more sensor hubs, and any other hardware configured to function as a processor, a processing unit, or a processing device. Computing system 30 may use one or more processors 32 to perform operations in accordance with one or more aspects of the present disclosure using software, hardware, firmware, or a mixture of hardware, software, and firmware residing in and/or executing at computing system 30.

One or more communication units 34 of computing system 30 may communicate with devices external to computing system 30 by transmitting and/or receiving data, and may operate, in some respects, as both an input device and an output device. In some examples, communication units 34 may communicate with other devices over a network. In other examples, communication units 34 may send and/or receive radio signals on a radio network such as a cellular radio network. In other examples, communication units 34 of computing system 30 may transmit and/or receive satellite signals on a satellite network such as a Global Positioning System (GPS) network. Examples of communication units 34 include a network interface card (e.g., such as an Ethernet card), an optical transceiver, a radio frequency transceiver, a GPS receiver, or any other type of device that can send and/or receive information. Other examples of communication units 34 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input/output devices 36 may represent any input or output devices of computing system 30 not otherwise separately described herein. One or more input/output devices 36 may generate, receive, and/or process input from any type of device capable of detecting input from a human or machine. One or more input/output devices 36 may generate, present, and/or process output through any type of device capable of producing output.

One or more storage devices 38 within computing system 30 may store information for processing during operation of computing system 30. Storage devices 38 may store program instructions and/or data associated with one or more of the modules described in accordance with one or more aspects of this disclosure. One or more processors 32 and one or more storage devices 38 may provide an operating environment or platform for such modules, which may be implemented as software, but may in some examples include any combination of hardware, firmware, and software. One or more processors 32 may execute instructions and one or more storage devices 38 may store instructions and/or data of one or more modules. The combination of processors 32 and storage devices 38 may retrieve, store, and/or execute the instructions and/or data of one or more applications, modules, or software. Processors 32 and/or storage devices 38 may also be operably coupled to one or more other software and/or hardware components, including, but not limited to, one or more of the components of computing system 30 and/or one or more devices or systems illustrated as being connected to computing system 30.

In some examples, one or more storage devices 38 are temporary memories, meaning that a primary purpose of the one or more storage devices is not long-term storage. Storage devices 38 of computing system 30 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 38, in some examples, also include one or more computer-readable storage media. Storage devices 38 may be configured to store larger amounts of information than volatile memory. Storage devices 38 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

According to the disclosed techniques, computing system 30 includes auto pay conversion manager 40 configured to autonomously manage conversion from a user performing manual payment of recurring bills with one or more billers to automatic payment of the recurring bills with the billers. Auto pay conversion manager 40 performs computer-based recognition of manual recurring transactions with a biller, and determination of a type of automatic payment for subsequent recurring transactions with the biller that has the highest probability of successful usage based on the transaction data of the recurring transactions, user profile data, and biller profile data. In addition, auto pay conversion manger 40 performs autonomous establishment of the recommended automatic payment with the biller-based payment service or the bank-based payment service.

Examples of different manual payment types include: manual paper-based payments in which the user writes a check or fills out a paper form with their payment card information for each bill and submits the paper payment via mail; manual phone-based payments in which the user provides their payment card information for each bill via telephone; and manual online-based payments in which the user fills out an online user interface form with their payment card information or their checking or savings account information for each bill via either a bank-based payment service or a biller-based payment service.

Examples of different automatic payment types include: automatic payment with the biller-based payment service in which each bill is automatically paid with either a payment card or an ACH payment based on payment information provided by the user upon enrollment; electronic billing with automatic payment by the bank-based payment service in which the biller sends each bill directly to the financial institution and the bank-based payment service automatically pays each bill with an inter-bank transfer and then deducts the funds from the user's account based on payment information provided by the user upon enrollment; and manually-scheduled automatic payment by the bank-based payment service in which the user manually schedules periodic payments with the biller for a set amount and the bank-based payment service automatically pays the biller according to the schedule and deducts the payment using payment information provided by the user upon enrollment.

In the illustrated example of FIG. 2, auto pay conversion manager 40 may perform functions relating to maintaining, updating, and interacting with an account database, e.g., account database 23 from FIG. 1, and a biller database, e.g., biller database 25 from FIG. 1. Auto pay conversion manager 40 may access, and in some cases maintain, user profile database 60 and transaction data records 62 within account database 23. User profile database 60 may include user profiles for one or more users of the financial institution, including account information, contact information, and preferred payment information. Transaction data records 62 may comprise records of all payment transactions performed by accounts at the financial institution. Auto pay conversion manager 40 may access, and in some cases maintain, biller profile database 55 within biller database 25. Biller profile database 55 may include biller profiles for one or more billers, including service type, contact information, and preferred payment information. In addition, auto pay conversion manager 40 may maintain and update auto pay records 64 that indicate users' enrollment in automatic payment services. Although illustrated in FIG. 2 as being included within computing system 30, in other examples, user profile database 60, transaction data records 62, biller profile database 55, and/or auto pay records 64 may be accessible to computing system 30 through a separate system.

Account analysis unit 44 of auto pay conversion manager 40 analyzes transaction data 62 associated with one or more accounts of the user to identify one or more recurring transactions with a particular biller that are manually performed by the user from at least one account of the one or more accounts, where the recurring transactions did not occur through a bank-based payment service and did not occur through automatic payment with a biller-based payment service. In some examples, the analysis of transaction data 62 may occur in response to a request from a user device during a communication session with an online banking system at least partially implemented by computing system 30. In other examples, the analysis of transaction data 62 may be performed periodically and/or in response to another request or event from one or more of a user device, a biller system, or internal systems within the bank network.

In one example, account analysis unit 44 may analyze transaction data 62 associated with the one or more accounts of the user to identify two or more transactions with the particular biller, and determine that the two or more transactions occurred according to approximately a same periodic interval and for approximately a same amount. For example, account analysis unit 44 may identify monthly transactions with the same biller that occur sometime within the first ten days of each month and that are for a set amount or a varying amount within a certain range such that the transactions are likely to be recurring transactions for a periodically billed service provided to the user by the biller. In this example, based on the payment details of the two or more transactions, account analysis unit 44 may identify the two or more transactions as the recurring transactions with the biller.

In another example, account analysis unit 44 may analyze transaction data 62 associated with the one or more accounts of the user to identify one or more transactions with the particular biller, and compare the particular biller against biller profile database 55 to identify the biller as a service provider having a periodic billing cycle. For example, account analysis unit 44 may identify even a single transaction from a biller that is a known monthly service provider, e.g., Netflix®, Verizon®, AT&T®, based on the biller's inclusion in biller profile database 55 such that the single transaction is likely to be the start of recurring transactions for the periodically billed service provided to the user by the biller. In this example, based on the profile of the particular biller, account analysis unit 44 may identify the one or more transactions as being recurring transactions with the biller.

In either of the above examples, account analysis unit 44 may further determine, based on one or more of transaction data 62 or automatic payment records 64 of the user, that the identified transactions did not occur through the bank-based payment service of the online banking system and did not occur through automatic payment with the biller-based payment service. For example, account analysis unit 44 may determine that the recurring transactions did not occur through any type of automatic payment service based on automatic payment records 64 of the user that indicate the user's enrollment in automatic payment services. In other examples, account analysis unit 44 may determine that the identified transactions did not occur through any type of automatic payment service based on variations in the transactions, such as payment on different days in successive pay periods or payment from different accounts of the user in successive pay periods. For example, account analysis unit 44 may determine that the transactions with the biller were manually paid by the user based on the identified transactions being off a day or two each month. As an example, in month one, the payment is initiated on the third day of the month; in month two, the payment is initiated on the first day of the month; and in month three, the payment is initiated on the fifth day of the month; etc.

Account analysis unit 44 of auto pay conversion manager 40 next determines, based on the identified recurring transactions, a recommendation to automatically perform subsequent recurring transactions with the biller. For example, account analysis unit 44 may analyze the one or more identified recurring transactions, user profile data of the user from user profile database 60, and biller profile data of the biller from biller profile database 55, and determine a type of automatic payment for the subsequent recurring transactions with the biller based on the analysis. The types of automatic payment that may be identified by account analysis unit 44 may include: automatic payment with the biller-based payment service using a payment card; automatic payment with the biller-based payment service using an ACH payment; electronic billing with automatic payment by the bank-based payment service; and manually-scheduled automatic payment by the bank-based payment service.

In some examples, account analysis unit 44 may use one or more of ML models 54 to identify the type of automatic payment having a highest probability of successful usage for the subsequent recurring transactions with the biller. In general, a computing system uses a machine learning algorithm to build a model based on a set of training data such that the model “learns” how to make predictions, inferences, or decisions to perform a specific task without being explicitly programmed to perform the specific task. Once trained, the computing system applies or executes the trained model to perform the specific task based on new data. Examples of machine learning algorithms and/or computer frameworks for machine learning algorithms used to build the models may include a gradient boosting algorithm, a random forest algorithm, or an artificial neural network (ANN), such as a convolutional neural network (CNN).

According to the disclosed techniques, ML models 54 may be trained based on historic payment transaction data, profile data for a large population of customers and billers, and business rules that are weighted for preferred payment types. As one example, the preferred payment types may include, in preference order: payment card-based automatic payment with the biller-based payment service; electronic billing with automatic payment by the bank-based payment service via inter-bank transfer; automatic payment by the bank-based payment service via bank check or inter-bank transfer; and ACH-based automatic payment with the biller-based payment service. Once ML models 54 are trained, account analysis unit 44 may input the identified recurring transactions, user profile data of the user from user profile database 60, and biller profile data of the biller from biller profile database 55 as input to ML models 54, and identify the type of automatic payment that has a highest probability of successful usage by the user, the biller and/or the financial institution as output from ML models 54. In this way, ML models 54 may be configured to balance the preferences and requirements of the user, the biller, and/or the financial institution to identify the type of automatic payment that is the best fit for one or more of the parties.

In one example, the user and/or the financial institution may generally prefer credit card payments, but the biller may be unable to process credit card payments and may not be enrolled with the financial institution for electronic billing. In this example, ML models 54 may identify automatic payment by the bank-based payment service as the type of automatic payment that has the highest probability of successful usage. In another example, the user and/or the financial institution may again generally prefer credit card payments, but the biller may generally prefer ACH payments via the biller-based payment service. In this example, ML models 54 may identify payment card-based automatic payment with the biller-based payment service as the type of automatic payment that has the highest probability of successful usage despite the biller's preference. In a further example, the user and the biller may both prefer other methods to credit card payments. In this example, ML models 54 may identify one of electronic billing with automatic payment or just automatic payment by the bank-based payment service as the type of automatic payment that has the highest probability of successful usage based on which type of bank-based payment service the user is already using for other billers.

In some situations, particularly if the identified type of automatic payment does not fit with the user's preferences or current payment method, conversion offer unit 48 may generate, or identify from an existing list, an incentive or reward to offer to the user in exchange for switching to the identified automatic payment type. For example, the incentive or reward may be credit card points, free or reduced-price services, gift cards, cash, or the like.

Upon determining the recommendation, notification unit 50 of auto pay conversion manager 40 sends, to a user device of the user, a notification of the recurring transactions and the recommendation to automatically perform the subsequent recurring transactions with the biller. In the situations described above, notification unit 50 may also include a description of the incentive or reward in the notification that the user may collect upon switching to the recommended automatic payment type. In one example, where the online banking system at least partially implemented by computing system 30 has a current communication session established with the user device of the user, UI unit 52 may generate data representative of the notification from notification unit 50 for display on the user device as part of the GUI of the online banking system during the communication session. In other examples, where a current communication session is not established, notification unit 50 may send the notification as an electronic message to the user device via one of communication units 34. The electronic message may be one of an email, a short message service (SMS) notification, or a push notification via an application on the user device associated with the online banking system, e.g., a mobile banking app. In some examples, the electronic message may include a hyperlink to the GUI of the online banking system such that, upon selection of the hyperlink via the user device, the user device may establish a communication session with the online banking system to view the recurring transactions and/or the recommendation in greater detail.

In general, UI unit 52 may be configured to generate data representative of a user interface of the online banking system for display on the user device during the communication session. Upon sending the notification, UI unit 52 may further generate data representative of a recommendation user interface including a payment history of the user with the biller including the identified recurring transactions with the biller and the recommendation to automatically perform the subsequent recurring transactions with the biller including a prompt to approve or deny the recommendation. For example, UI unit 52 may receive, in response to the prompt, a selection to approve the recommendation via the recommendation user interface.

Auto pay provisioning unit 46 may receive input data representative of an approval of the recommendation from the user device during the communication session, e.g., via the recommendation user interface prompt. In response, auto pay provisioning unit 46 establishes automatic payment of the subsequent recurring transactions with the biller. Upon establishment of the automatic payment of the subsequent recurring transactions with the biller, auto pay provisioning unit 46 may record the newly established automatic payment information in one of automatic payment records 64.

For example, auto pay provisioning unit 46 may interact with UI unit 52 to generate data representative of an automatic payment confirmation user interface for display on the user device during the communication session. Auto pay provisioning unit 46 may then receive, from the user device via the automatic payment confirmation user interface, confirmation of payment information for the subsequent recurring transactions with the biller. The payment information to be confirmed, modified, or input by the user includes one or more of a payee name (i.e., the biller's name), a payee account number (i.e., the user's account number with the biller), payee access information (e.g., the biller's physical address or website address, and in some examples, login credentials for the biller's website), payment account information (i.e., the user's account for the payment), a payment frequency (e.g., monthly), and a payment date relative to the payment frequency (e.g., the 3^{rd} day of each month).

In one specific example, auto pay provisioning unit 46 may interact with UI unit 52 to generate data representative of one or more prompts and one or more fillable fields designed to capture input representative of the payment information responsive to the corresponding prompts. Auto pay provisioning unit 46 may then prefill at least a portion of the one or more fillable fields of the automatic payment confirmation user interface with at least a portion of the payment information that is already known or may be inferred from user profile data of the user from user profile database 60, biller profile data of the biller from biller profile database 55, and the identified recurring transactions from transaction data 62. Auto pay provisioning unit 46 may receive, from the user device, one or more inputs to the fillable fields of the automatic payment confirmation user interface that are representative of one or more of modifications to the portion of the payment information or a remaining portion of the payment information.

Auto pay provisioning unit 46 may then establish the automatic payment of the subsequent recurring transactions with the biller based on the confirmed payment information received via the automatic payment confirmation user interface. In some examples, auto pay provisioning unit 46 may use API 42, one of communication units 34, or another interface of computing system 30 to communicate with a biller system, e.g., one of biller systems 28 from FIG. 1, that is hosting the biller-based payment service. As one example, auto pay provisioning unit 46 may autonomously schedule the automatic payment of the subsequent recurring transactions with the biller via the biller-based payment service. In this example, auto pay provisioning unit 46 may autonomously enroll the user in the biller-based payment service based on the payee name, the payee account number, and the payee access information included in the payment information. Auto pay provisioning unit 46 may then provide, to the biller-based payment service, the payment account information for the subsequent recurring transactions with the biller according to the payment frequency and the payment date relative to the payment frequency.

In some examples, auto pay provisioning unit 46 may establish the automatic payment using a biller-specific virtual card that is linked to a selected account of the user. For example, the virtual card may be created such that only the particular biller may use the virtual card account number to receive payment on a specified date and for a specified amount. The payment with the virtual card is then settled to the user's selected account without revealing the account number of the user's selected account to the biller. More details with respect to a virtual card payment system in the context of business-to-business payments may be found in U.S. patent application Ser. No. 17/143,038, filed Jan. 6, 2021, entitled “Virtual Card Payments System,” (Attorney Docket No. 1234-210US01), the entire content of which is incorporated herein by reference.

Modules illustrated in FIG. 2 (e.g., account analysis unit 44, auto pay provisioning unit 46, conversion offer unit 48, notification unit 50, and UI unit 52) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

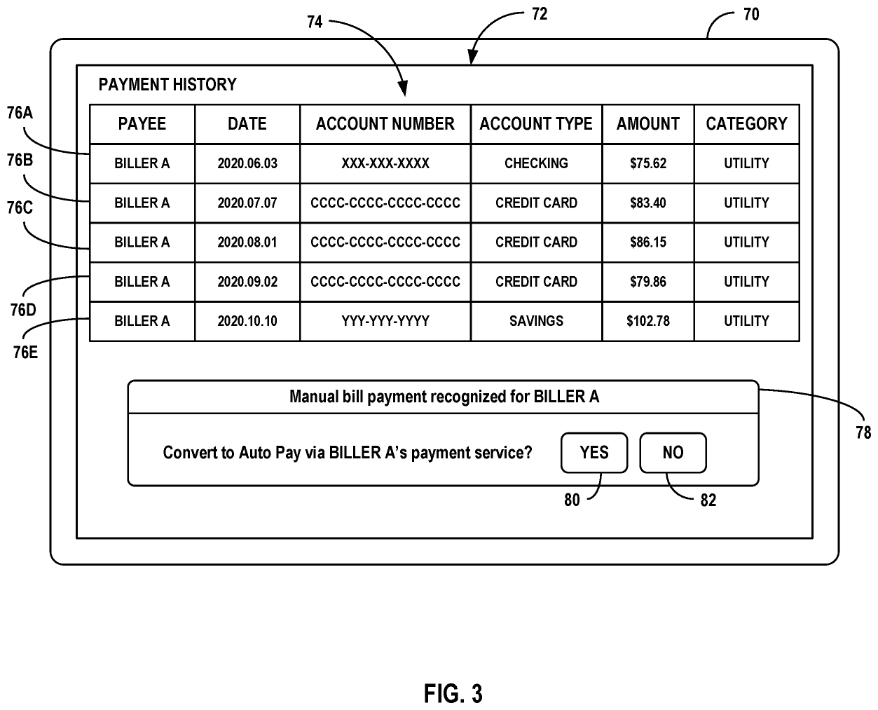

FIG. 3 is a conceptual diagram illustrating an example recommendation user interface 72 of an online banking system used to present a payment history 74 including recurring transactions and a recommendation 78 to automatically perform the recurring transactions, in accordance with the techniques of this disclosure.

As described above with respect to FIG. 2, auto pay conversion manager 40 is configured to identify recurring transactions with a particular biller that are manually performed by a user from one or more accounts of the user, and determine a recommendation to automatically perform subsequent recurring transactions with the biller via a type of automatic payment. In some examples, auto pay conversion manager 40 may send data representative of recommendation user interface 72 for display on a display device 70 associated with the user device of the user. As illustrated in FIG. 3, recommendation user interface 72 includes payment history 74 including the identified recurring transactions and recommendation 78 to switch to a particular type of automatic payment. Although not illustrated in FIG. 3, in some examples recommendation user interface 72 may further include a description of the incentive or reward that the user may collect upon switching to the recommended automatic payment type.

Payment history 74 is presented as a table that includes entries 76A-76E (collectively, “entries 76”) of recurring payments identified from the one or more accounts of the user and with the particular biller. Entries 76 may represent the most recent transactions associated with the accounts of the user and the particular biller. As illustrated in FIG. 3, each of the entries 76 within payment history 74 includes the following data fields: payee name, date, account number, account type, amount, and category. The payee name field indicates the name of the particular biller, e.g., Biller A. The date field indicates the date on which the transaction with the biller was performed. The account number field indicates the account number of the user's account that was used to perform the transaction. The account type filed indicates the type of account that was used to perform the transaction, e.g., checking, savings, credit card, debit card. The amount field indicates the amount of the payment. The category field indicates a category of the biller, e.g., utility, services, entertainment, etc.

In the example illustrated in FIG. 3, payment history 74 includes six recurring transactions with Biller A that have been determined to be manually performed by the user from the user's one or more accounts. In particular, entries 76 indicate that the payments are monthly transactions with Biller A that occur sometime within the first ten days of each month and that are for a varying amount within a certain range. In this example, the user has performed the manual payments from multiple different accounts, include checking, credit card, and savings, which may indicate that the user does not have a preferred payment method.

Recommendation 78 includes an explanation that manual recurring payments were recognized for the particular biller, e.g., “Manual bill payment recognized for Biller A.”Recommendation 78 also includes a description of the type of automatic payment recommended for the user and the particular biller, e.g., “Convert to Auto Pay via Biller A's payment service?” as a prompt to approve or deny the recommendation. Recommendation 78 further includes a “YES” button 80 and a “NO” button 82 configured to receive a selection to approve or deny the recommendation, respectively, from the user device via recommendation user interface 72.

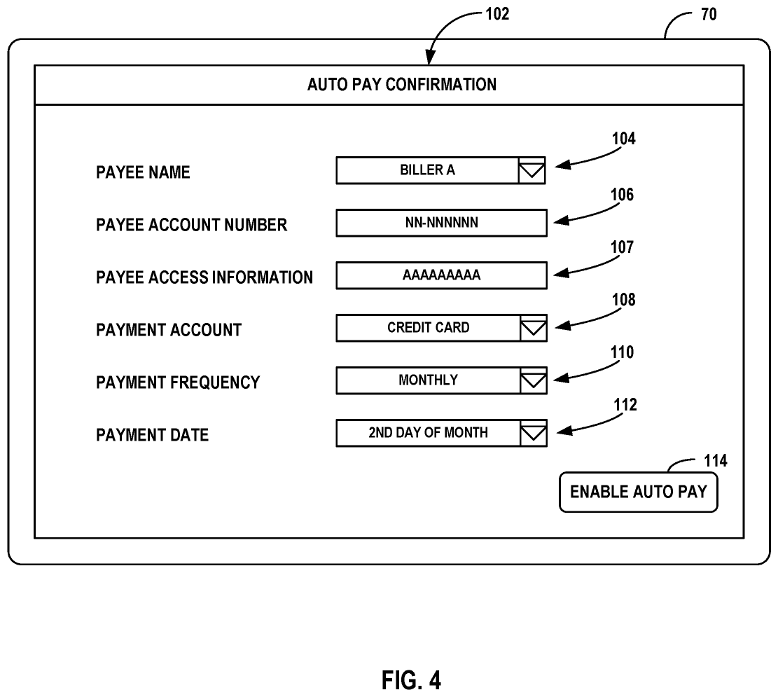

FIG. 4 is a conceptual diagram illustrating an example automatic payment confirmation user interface 102 of the online banking system used to present payment information and a receive modifications or confirmation of the payment information for automatic payments, in accordance with the techniques of this disclosure. In some example, auto pay conversion manager 40 may trigger display of automatic payment confirmation user interface 102 in response to receipt of an approval of the recommendation to switch to a type of automatic payment to perform the identified recurring transactions with the particular biller (e.g., a selection of YES button 80 of recommendation user interface 72 from FIG. 3).

As described above with respect to FIG. 2, auto pay conversion manager 40 is configured to generating data representative of automatic payment confirmation user interface 102 for display on display device 70 associated with the user device of the user in order to receive confirmation of payment information for the subsequent recurring transactions with the particular biller from the user device via automatic payment confirmation interface 102.

Auto pay confirmation user interface 102 includes one or more prompts and one or more fillable fields designed to capture input representative of the payment information responsive to the corresponding prompts from the user device. As illustrated in FIG. 4, auto pay confirmation user interface 102 includes: a payee name prompt and corresponding fillable field 104, a payee account number prompt and corresponding fillable field 106, a payee access information prompt and corresponding fillable field 107, a payment account prompt and corresponding fillable field 108, a payment frequency prompt and corresponding fillable field 110, and a payment date prompt and corresponding fillable field 112. As described above, auto pay conversion manager 40 may prefill at least a portion of fillable fields 104, 106, 107, 108, 110, and 112 of automatic payment confirmation user interface 102 with at least a portion of the payment information that is already known or may be inferred from user profile data, biller profile data, and the identified recurring transactions. Auto pay confirmation user interface 102 may receive, from the user device, one or more inputs to the fillable fields, where the input may comprise modifications to the prefilled payment information or newly input payment information.

In the example illustrated in FIG. 4, fillable field 104 corresponding to the payee name prompt comprises a drop-down menu with known biller names. Based on the identified recurring transactions, as displayed via recommendation user interface 72 from FIG. 3, auto pay conversion manager 40 may prefill “Biller A” into fillable field 104. Fillable field 106 corresponding to the payee account number prompt comprises a text box configured to receive the user's account number with the biller to ensure the automatic payments of the subsequent recurring transactions are associated with the correct services. Fillable field 107 corresponding to the payee access information prompt comprises a text box configured to receive the biller's physical address or the biller's website address. In some cases, based on biller profile data, auto pay conversion manager 40 may prefill a known address for the biller into fillable field 107. In some examples, fillable field 107 may be further configured to receive login credentials for the biller's website.

Fillable field 108 corresponding to the payment account information prompt comprises a drop-down menu with the user's account number or account nicknames. Based on the identified recurring transactions and/or user profile data, auto pay conversion manager 40 may prefill “Credit Card” into fillable field 108 as the payment account for the automatic payments. In some cases, the user may interact with auto pay confirmation user interface 102 via the user device to modify the prefilled payment account. Fillable field 110 corresponding to the payment frequency prompt comprises a drop-down menu with common billing cycle frequencies. Based on the identified recurring transactions, auto pay conversion manager 40 may prefill “Monthly” into fillable field 110. Fillable field 112 corresponding to the payment date prompt comprises a drop-down menu with relative dates for the selected payment frequency. Based on the identified recurring transactions and/or biller profile data, auto pay conversion manager 40 may prefill “2^{nd} Day of Month” into fillable field 112. In some cases, the user may interact with auto pay confirmation user interface 102 via the user device to modify the prefilled payment date.

Auto pay confirmation user interface 102 also includes an “Enable Auto Pay” button 114 configured to receive a selection to confirm the payment information for the subsequent recurring transactions from the user device. In response to the selection of the “Enable Auto Pay” button 114, auto pay conversion manager may proceed with establishing the automatic payment of the subsequent recurring transactions with the biller.

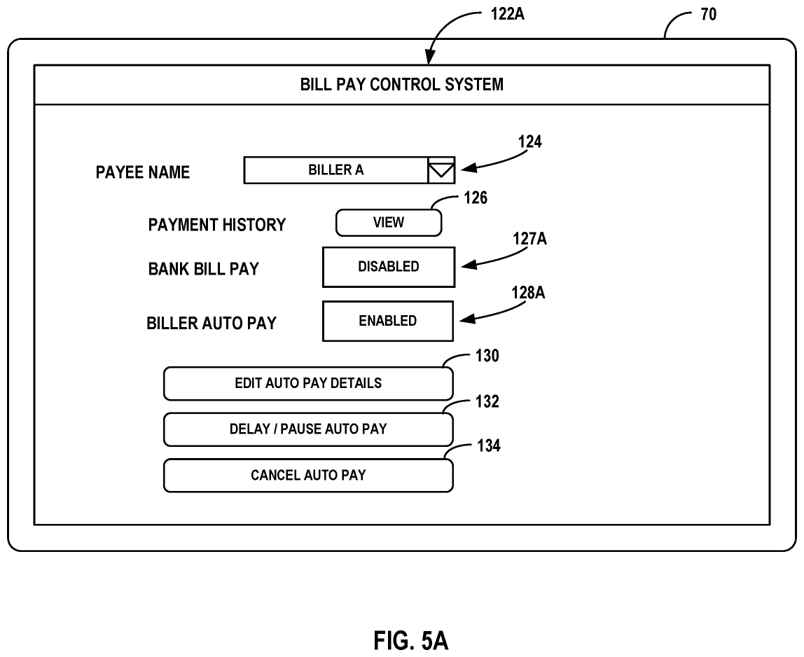

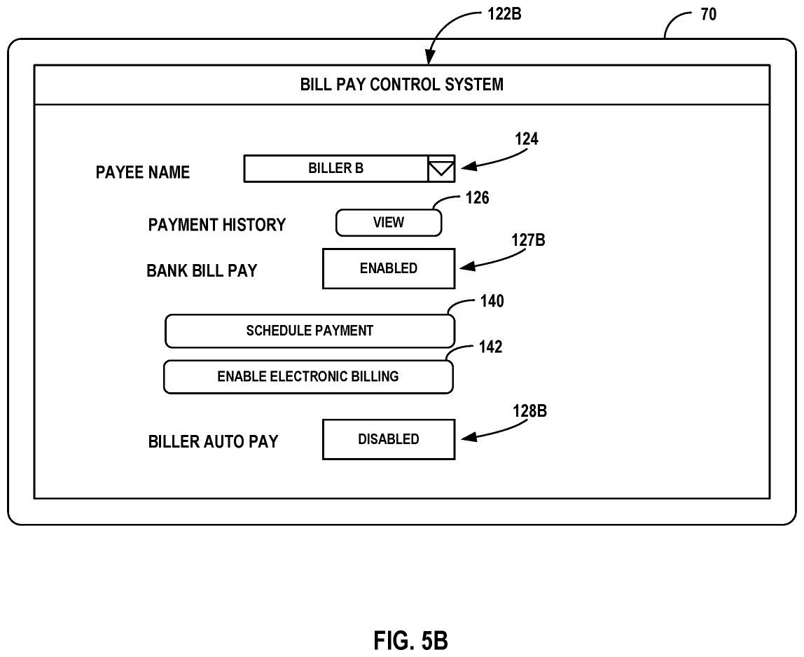

FIGS. 5A and 5B are conceptual diagrams illustrating examples of a bill pay control user interface 122A, 122B of the online banking system used to present bill pay settings, in accordance with the techniques of this disclosure. In some example, auto pay conversion manager 40 may trigger display of bill pay control user interface 122A, 122B in response to establishment of a new automatic payment for the user with a particular biller. In other examples, the online banking system at least partially implemented by computing system 30 may trigger display of bill pay control user interface 122A, 122B in response to a request from the user device of the user during a communication session with the online banking system. In general, the online banking system is configured to generate data representative of bill pay control user interface 122A, 122B for display on display device 70 associated with the user device of the user to enable the user to view and modify types of bill payment services established for different billers.

FIG. 5A illustrates an example of bill pay control user interface 122A including one or more buttons, and one or more prompts with corresponding fields designed to output data representative of control information for bill payment services. As illustrated in FIG. 5A, bill pay control user interface 122A includes a payee name prompt and a corresponding fillable field 124 that comprises a drop-down menu with known biller names. The user may interact with bill pay control user interface 122A via the user device to select the biller for which the user wants to view and/or modify bill payment services. In the example of FIG. 5A, “Biller A” is selected in fillable field 124. Bill pay control user interface 122A also includes a payment history “View” button 126. In response to the selection of “View” button 122, the online banking system may present a user interface on the user device that includes a payment history for the selected biller in fillable field 124, e.g., substantially similar to payment history table 74 of recommendation user interface 72 from FIG. 3.

Bill pay control user interface 122A also includes a bank bill pay prompt with a corresponding status indicator button 127A set to “Disabled,” and a biller auto pay prompt with a corresponding status indicator button 128A set to “Enabled.” Each of the status indicator buttons 127A, 128A may be a toggle or radio button that enables the user to change the status of the respective bill payment service, e.g., from enabled to disabled or vice versa, by simply selecting the one of status indicator buttons 127A, 128A. In the example of FIG. 5A, the bank-based payment service (i.e., “bank bill pay” in FIG. 5A) is disabled and automatic payment via the biller-based payment service (i.e., “biller auto pay” in FIG. 5A) is enabled.

Based on the biller-based payment service being enabled, bill pay control user interface 122A displays additional control buttons for the user to manage the biller-based payment service for the selected biller (i.e., “Biller A” in FIG. 5A). For example, FIG. 5A includes an “Edit Auto Pay Details” button 130, a “Delay/Pause Auto Pay” button 132, and a “Cancel Auto Pay” button 134. In response to the selection of any of buttons 130, 132, 134, the online banking system may present a respective user interface on the user device that enables the user to make the requested modifications to, respectively, edit the payment information for the automatic payments with Biller A, delay or pause a next scheduled automatic payment with Biller A, or cancel the automatic payment service for Biller A.

FIG. 5B illustrates an example of bill pay control user interface 122B including one or more buttons, and one or more prompts with corresponding fields designed to output data representative of control information for bill payment services. As illustrated in FIG. 5B, bill pay control user interface 122B includes payee name prompt and corresponding fillable field 124 that comprises a drop-down menu with known biller names. In the example of FIG. 5B, “Biller B” is selected in fillable field 124. Bill pay control user interface 122B also includes the payment history “View” button 126. In response to the selection of “View” button 122, the online banking system may present a user interface on the user device that includes a payment history for the selected biller in fillable field 124, e.g., substantially similar to payment history table 74 of recommendation user interface 72 from FIG. 3.

Bill pay control user interface 122B also includes the bank bill pay prompt with the corresponding status indicator button 127B set to “Enabled,” and the biller auto pay prompt with the corresponding status indicator button 128A set to “Disabled.” Each of the status indicator buttons 127B, 128B may be a toggle or radio button that enables the user to change the status of the respective bill payment service, e.g., from enabled to disabled or vice versa, by simply selecting the one of status indicator buttons 127B, 128B. In the example of FIG. 5B, the bank-based payment service (i.e., “bank bill pay” in FIG. 5B) is enabled and automatic payment via the biller-based payment service (i.e., “biller auto pay” in FIG. 5B) is disabled.

Based on the bank-based payment service being enabled, bill pay control user interface 122B displays additional control buttons for the user to manage the bank-based payment service for the selected biller (i.e., “Biller B” in FIG. 5B). For example, FIG. 5B includes a “Schedule Payment” button 140 and an “Enable Electronic Billing” button 142. In response to the selection of any of buttons 140, 142, the online banking system may present a respective user interface on the user device that enables the user to make the requested updates to, respectively, schedule subsequent automatic payments or modify previously scheduled subsequent automatic payments with Biller B, or enable electronic billing for Biller B such that the financial institution receives each bill directly from Biller B and the bank-based payment service automatically pays each bill.

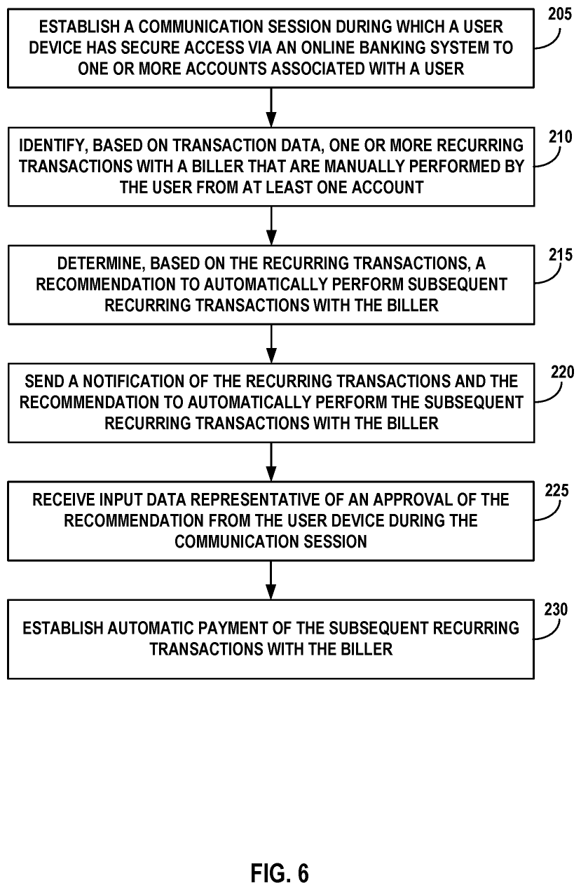

FIG. 6 is a flowchart illustrating an example operation of an automatic payment conversion manager running on a computing system, in accordance with the techniques of this disclosure. The example operation of FIG. 6 is described with respect to auto pay conversion manager 40 running on computing system 30 from FIG. 2. In other examples, the operation of FIG. 6 may be performed by auto pay conversion manager 20 running on computing system 18 from FIG. 1.

Auto pay conversion manager 40 establishes a communication session with a user computing device, e.g., user device 16A from FIG. 1, during which user device 16A has secure access via an online banking system of bank network 12 to one or more accounts associated with a user of user device 16A (205).

Upon receipt of a request from user device 16A during the communication session or in response to another, internal request or event, auto pay conversion manager 40 identifies, based on transaction data 62 associated with the one or more accounts of the user, one or more recurring transactions with a biller that are manually performed by the user from at least one account (210). The recurring transactions include transactions that did not occur through a bank-based payment service of the online banking system and did not occur through automatic payment with a biller-based payment service. Auto pay conversion manager 40 determines, based on the recurring transactions, a recommendation to automatically perform subsequent recurring transactions with the biller (215).

Auto pay conversion manager 40 then sends, to user device 16A, a notification of the recurring transactions and the recommendation to automatically perform the subsequent recurring transactions with the biller (220). In response to the notification, auto pay conversion manager 40 may receive input data representative of an approval of the recommendation from user device 16A during the communication session (225). Auto pay conversion manager 40 then establishes automatic payment of the subsequent recurring transactions with the biller, e.g., via a biller-based payment service of biller system 26A from FIG. 1 (230).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A computer-implemented method comprising:
training, by a computing system, a machine learning-based model to identify a type of automatic payment from a plurality of types of automatic payment based on historic payment transaction data, profile data for a population of customers and billers, and business rules that are weighted for preferred types of automatic payment from the plurality of types of automatic payment;
establishing, by the computing system, a communication session with a user computing device during which the user computing device has secure access via an online banking system of a financial institution to one or more accounts associated with a user of the user computing device;
identifying, by the computing system and based on transaction data associated with the one or more accounts of the user, one or more recurring transactions with a biller that are manually performed by the user from at least one account of the one or more accounts, wherein the recurring transactions did not occur through a bank-based payment service of the online banking system and did not occur through automatic payment with a biller-based payment service;
determining, by the computing system based on the recurring transactions, a recommendation to automatically perform subsequent recurring transactions with the biller using a particular type of automatic payment from the plurality of types of automatic payment, wherein determining the recommendation to automatically perform subsequent recurring transactions with the biller using the particular type of automatic payment comprises:
analyzing the one or more recurring transactions, user profile data of the user, and biller profile data of the biller as input to the machine learning-based model, and
identifying, as output from the machine learning-based model, the particular type of automatic payment from the plurality of types of automatic payment as having a highest probability of successful usage by one or more of the user, the biller, or the financial institution for the subsequent recurring transactions with the biller, wherein the plurality of types of automatic payment includes automatic payment with the biller-based payment service using a payment card, automatic payment with the biller-based payment service using an automated clearing house (ACH) payment, electronic billing with automatic payment by the bank-based payment service, and manually-scheduled automatic payment by the bank-based payment service;
sending, by the computing system and to the user computing device, a notification of the recurring transactions and the recommendation to automatically perform the subsequent recurring transactions with the biller using the particular type of automatic payment; and
based on receipt of input data representative of an approval of the recommendation from the user computing device during the communication session, establishing, by the computing system, the particular type of automatic payment for the subsequent recurring transactions with the biller, wherein establishing the particular type of automatic payment includes sending, by the computing system, a signal to one of a biller system or a payment system thereby instructing the one of the biller system or the payment system to perform the particular type of automatic payment for the subsequent recurring transactions with the biller.

2. The method of claim 1, wherein identifying the one or more recurring transactions with the biller comprises:
analyzing the transaction data associated with the one or more accounts of the user to identify two or more transactions with the biller;
determining that the two or more transactions occurred according to approximately a same periodic interval and for approximately a same amount;
determining, based on one or more of the transaction data or automatic payment records of the user, that the two or more transactions did not occur through the bank-based payment service of the online banking system and did not occur through automatic payment with the biller-based payment service; and
identifying the two or more transactions as the recurring transactions with the biller.

3. The method of claim 1, wherein identifying the one or more recurring transactions with the biller comprises:
analyzing the transaction data associated with the one or more accounts of the user to identify one or more transactions with the biller;
comparing the biller against a biller database to identify the biller as a service provider having a periodic billing cycle;
determining, based on one or more of the transaction data or automatic payment records of the user, that the one or more transactions did not occur through the bank-based payment service of the online banking system and did not occur through automatic payment with the biller-based payment service; and
identifying the one or more transactions as the recurring transactions with the biller.

4. (canceled)

5. (canceled)

6. The method of claim 1, wherein sending the notification comprises outputting the notification via one of:
a user interface of the online banking system displayed on the user computing device during the communication session, or
an electronic message including a hyperlink to the user interface of the online banking system, wherein the electronic message comprises one of an email, a short message service (SMS) notification, or a push notification via an application on the user computing device associated with the online banking system.

7. The method of claim 1, further comprising generating data representative of a user interface of the online banking system for display on the user computing device during the communication session, wherein the data representative of the user interfaces includes data representative of a payment history of the user with the biller including the recurring transactions with the biller and data representative of the recommendation to automatically perform the subsequent recurring transactions with the biller using the particular type of automatic payment, and wherein the data representative of the recommendation includes a prompt to approve or deny the recommendation, and
wherein receiving the input data representative of the approval of the recommendation comprising receiving, in response to the prompt, a selection to approve the recommendation via the user interface.

8. The method of claim 1, wherein establishing the particular type of automatic payment for the subsequent recurring transactions with the biller comprises:
generating data representative of a user interface for display on the user computing device during the communication session;
receiving, by the computing device and from the user computing device via the user interface, confirmation of payment information for the subsequent recurring transactions with the biller, wherein the payment information includes one or more of a payee name, a payee account number, payee access information, payment account information, a payment frequency, and a payment date relative to the payment frequency; and
establishing, based on the payment information received via the user interface, the particular type of automatic payment for the subsequent recurring transactions with the biller.

9. The method of claim 8, wherein the particular type of automatic payment comprises one of automatic payment with the biller-based payment service using a payment card or automatic payment with the biller-based payment service using an ACH payment, wherein establishing the particular type of automatic payment for the subsequent recurring transactions comprises autonomously scheduling automatic payment of the subsequent recurring transactions with the biller via the biller-based payment service using the one of the payment card or the ACH payment, wherein autonomously scheduling the automatic payment comprises:
sending a first signal to the biller system thereby instructing the biller system to enroll the user in the biller-based payment service based on the payee name, the payee account number, and the payee access information included in the payment information; and
sending a second signal to the biller system thereby instructing the biller system to schedule the automatic payment of the subsequent recurring transactions with the biller the biller-based payment service based on the payment account information in accordance with the payment frequency and the payment date relative to the payment frequency.

10. The method of claim 8,
wherein generating the data representative of the user interface comprises:
generating data representative of one or more prompts and one or more fillable fields designed to capture input representative of the payment information responsive to the corresponding prompts, and
prefilling at least a portion of the one or more fillable fields of the user interface with at least a portion of the payment information; and
wherein receiving confirmation of the payment information for the subsequent recurring transactions with the biller comprises receiving, from the user computing device, one or more inputs to the fillable fields of the user interface that are representative of one or more of modifications to the portion of the payment information or a remaining portion of the payment information.

11. A computing system comprising:
one or more storage devices; and
processing circuitry having access to the storage devices and configured to:
train a machine learning-based model to identify a type of automatic payment from a plurality of types of automatic payment based on historic payment transaction data, profile data for a large population of customers and billers, and business rules that are weighted for preferred types of automatic payment from the plurality of types of automatic payment;
establish a communication session with a user computing device during which the user computing device has secure access via an online banking system of a financial institution to one or more accounts associated with a user of the user computing device;
identify, based on transaction data associated with the one or more accounts of the user, one or more recurring transactions with a biller that are manually performed by the user from at least one account of the one or more accounts, wherein the recurring transactions did not occur through a bank-based payment service of the online banking system and did not occur through automatic payment with a biller-based payment service;
determine, based on the recurring transactions, a recommendation to automatically perform subsequent recurring transactions with the biller using a particular type of automatic payment from the plurality of types of automatic payment, wherein to determine the recommendation to automatically perform subsequent recurring transactions with the biller using the particular type of automatic payment, the processing circuitry is configured to:
analyze the one or more recurring transactions, user profile data of the user, and biller profile data of the biller as input to the machine learning-based model, and
identify, as output from the machine learning-based model, the particular type of automatic payment from the plurality of types of automatic payment as having a highest probability of successful usage by one or more of the user, the biller, or the financial institution for the subsequent recurring transactions with the biller, wherein the plurality of types of automatic payment includes automatic payment with the biller-based payment service using a payment card, automatic payment with the biller-based payment service using an automated clearing house (ACH) payment, electronic billing with automatic payment by the bank-based payment service, and manually-scheduled automatic payment by the bank-based payment service;
send, to the user computing device, a notification of the recurring transactions and the recommendation to automatically perform the subsequent recurring transactions with the biller using the particular type of automatic payment; and
based on receipt of input data representative of an approval of the recommendation from the user computing device during the communication session, establish the particular type of automatic payment for the subsequent recurring transactions with the biller, wherein to establish the particular type of automatic payment, the processing circuitry is configured to send a signal to one of a biller system or a payment system thereby instructing the one of the biller system or the payment system to perform the particular type of automatic payment for the subsequent recurring transactions with the biller.

12. The computing system of claim 11, wherein to identify the one or more recurring transactions with the biller, the processing circuitry is configured to:
analyze the transaction data associated with the one or more accounts of the user to identify two or more transactions with the biller;
determine that the two or more transactions occurred according to approximately a same periodic interval and for approximately a same amount;
determine, based on one or more of the transaction data or automatic payment records of the user, that the two or more transactions did not occur through the bank-based payment service of the online banking system and did not occur through automatic payment with the biller-based payment service; and
identify the two or more transactions as the recurring transactions with the biller.

13. The computing system of claim 11, wherein to identify the one or more recurring transactions with the biller, the processing circuitry is configured to:
analyze the transaction data associated with the one or more accounts of the user to identify one or more transactions with the biller;
compare the biller against a biller database to identify the biller as a service provider having a periodic billing cycle;
determine, based on one or more of the transaction data or automatic payment records of the user, that the one or more transactions did not occur through the bank-based payment service of the online banking system and did not occur through automatic payment with the biller-based payment service; and
identify the one or more transactions as the recurring transactions with the biller.

14. (canceled)

15. (canceled)

16. The computing system of claim 11, wherein to send the notification, the processing circuitry is configured to output the notification via one of:
a user interface of the online banking system displayed on the user computing device during the communication session, or
an electronic message including a hyperlink to the user interface of the online banking system, wherein the electronic message comprises one of an email, a short message service (SMS) notification, or a push notification via an application on the user computing device associated with the online banking system.

17. The computing system of claim 11, wherein the processing circuitry is further configured to generate data representative of a user interface of the online banking system for display on the user computing device during the communication session, wherein the data representative of the user interfaces includes data representative of a payment history of the user with the biller including the recurring transactions with the biller and data representative of the recommendation to automatically perform the subsequent recurring transactions with the biller using the particular type of automatic payment, and wherein the data representative of the recommendation includes a prompt to approve or deny the recommendation, and
wherein to receive the input data representative of the approval of the recommendation, the processing circuitry is configured to receive, in response to the prompt, a selection to approve the recommendation via the user interface.

18. The computing system of claim 11, wherein to establish the particular type of automatic payment for the subsequent recurring transactions within with the biller, the processing circuitry is configured to:
generate data representative of a user interface for display on the user computing device during the communication session;
receive, from the user computing device via the user interface, confirmation of payment information for the subsequent recurring transactions with the biller, wherein the payment information includes one or more of a payee name, a payee account number, payee access information, payment account information, a payment frequency, and a payment date relative to the payment frequency; and
establish, based on the payment information received via the user interface, the particular type of automatic payment for the subsequent recurring transactions with the biller.

19. The computing system of claim 18, wherein the particular type of automatic payment comprises one of automatic payment with the biller-based payment service using a payment card or automatic payment with the biller-based payment service using an ACH payment, wherein to establish the particular type of automatic payment for the subsequent recurring transactions, the processing circuitry is configured to autonomously schedule automatic payment of the subsequent recurring transactions with the biller via the biller-based payment service using the one of the payment card or the ACH payment, wherein to autonomously schedule the automatic payment, the processing circuitry is configured to:
send a first signal to the biller system thereby instructing the biller system to enroll the user in the biller-based payment service based on the payee name, the payee account number, and the payee access information included in the payment information; and
send a second signal to the biller system thereby instructing the biller system to schedule the automatic payment of the subsequent recurring transactions with the biller via the biller-based payment service based on the payment account information in accordance with the payment frequency and the payment date relative to the payment frequency.

20. A non-transitory computer readable medium including instructions that when executed cause one or more processors to:
train a machine learning-based model to identify a type of automatic payment from a plurality of types of automatic payment based on historic payment transaction data, profile data for a population of customers and billers, and business rules that are weighted for preferred types of automatic payment from the plurality of types of automatic payment;
establish a communication session with a user computing device during which the user computing device has secure access via an online banking system of a financial institution to one or more accounts associated with a user of the user computing device;
identify, based on transaction data associated with the one or more accounts of the user, one or more recurring transactions with a biller that are manually performed by the user from at least one account of the one or more accounts, wherein the recurring transactions did not occur through a bank-based payment service of the online banking system and did not occur through automatic payment with a biller-based payment service;
determine, based on the recurring transactions, a recommendation to automatically perform subsequent recurring transactions with the biller, wherein to determine the recommendation to automatically perform subsequent recurring transactions with the biller using a particular type of automatic payment from the plurality of types of automatic payment, the instructions cause the one or more processors to:
analyze the one or more recurring transactions, user profile data of the user, and biller profile data of the biller as input to the machine learning-based model, and
identify, as output from the machine learning-based model, the particular type of automatic payment from the plurality of types of automatic payment as having a highest probability of successful usage by one or more of the user, the biller, or the financial institution for the subsequent recurring transactions with the biller, wherein the plurality of types of automatic payment includes automatic payment with the biller-based payment service using a payment card, automatic payment with the biller-based payment service using an automated clearing house (ACH) payment, electronic billing with automatic payment by the bank-based payment service, and manually-scheduled automatic payment by the bank-based payment service;
send, to the user computing device, a notification of the recurring transactions and the recommendation to automatically perform the subsequent recurring transactions with the biller using the particular type of automatic payment; and
based on receipt of input data representative of an approval of the recommendation from the user computing device during the communication session, establish the particular type of automatic payment for the subsequent recurring transactions with the biller, wherein to establish the particular type of automatic payment, the instructions cause the one or more processors to send a signal to one of a biller system or a payment system thereby instructing the one of the biller system or the payment system to perform the particular type of automatic payment for the subsequent recurring transactions with the biller.

21. The method of claim 1, wherein sending the signal thereby instructing the one of the biller system or the payment system to perform the particular type of automatic payment comprises:
sending a first signal to the biller system thereby instructing the biller system to enroll the user in the biller-based payment service; and
sending a second signal to the biller system thereby instructing the biller system to schedule performance of the particular type of automatic payment for the subsequent recurring transactions with the biller.

22. The method of claim 1, wherein sending the signal thereby instructing the one of the biller system or the payment system to perform the particular type of automatic payment comprises sending a signal to a bank payment system thereby instructing the bank payment system to enroll the user in the bank-based payment service to perform the particular type of automatic payment for the subsequent recurring transactions with the biller.

23. The method of claim 1, wherein sending the signal thereby instructing the one of the biller system or the payment system to perform the particular type of automatic payment comprises:
sending a first signal to a third-party payment system thereby instructing the third-party payment system to enroll the user in the biller-based payment service via the biller system; and
sending a second signal to the third-party payment system thereby instructing the third-party payment system to schedule performance of the particular type of automatic payment for the subsequent recurring transactions with the biller via the biller system.

24. The computing system of claim 11, wherein to send the signal thereby instructing the one of the biller system or the payment system to perform the particular type of automatic payment, the processing circuitry is configured to:
send a first signal to the biller system thereby instructing the biller system to enroll the user in the biller-based payment service; and
send a second signal to the biller system thereby instructing the biller system to schedule performance of the particular type of automatic payment for the subsequent recurring transactions with the biller.
